(19) United States
(12) Patent Application Publication
(10) Pub. No.: US 2007/0216796 A1
(43) Pub. Date: Sep. 20, 2007

(54) Focussing of a Digital Camera

(76) Inventors: Ursula Ruth Lenel, Cambridge (GB); Anthony Hooley, Cambrige (GB)

Correspondence Address: NIXON & VANDERHYE, PC, 901 NORTH GLEBE ROAD, 11TH FLOOR, ARLINGTON, VA, 22203, US

(21) Appl. No.: 10/594,125

(22) PCT Filed: Mar. 23, 2005
(86) PCT No.: PCT/GB05/01123

§ 371 Date: Sep. 25, 2006

(30) Foreign Application Priority Data
Mar. 25, 2004 (GB) 0406730.2

(51) Int. Cl. G03B 13/00

(52) U.S. Cl. 348/345

(57) ABSTRACT

A digital camera comprises an image sensor for capturing an image, a lens arrangement arranged to focus light onto the image sensor and providing a variable focus, and a memory for storing images captured by the image sensor. Focusing is achieved by a series of images having differing focus provided by the lens arrangement being captured by the image sensor and stored in the memory. Analysis of the images stored in the memory to determine the quality of the focus of the images is used to derive an in-focus image from the series of images. This avoids the complication of employing autofocusing control of the lens arrangement. Movement of the lens arrangement may be driven by movement of a button operable by a user which avoids the need for an actuator for the lens arrangement.

This invention relates to digital cameras, for example miniature cameras for use in portable electronic equipment such as a mobile telephone, a Personal Digital Assistant (PDA), a portable computer, or a digital camera per se. Such digital cameras have an image sensor which captures images and a lens arrangement which focuses light onto the image sensor.

The invention is particularly concerned with focusing of a digital camera in which the lens arrangement has a variable focus, typically by the lens arrangement being movable.

Many digital cameras are furnished with an autofocus facility. In general the autofocus algorithm may be closed-loop or open-loop. Typically, in known closed-loop autofocus algorithms an actuator moves the lens arrangement and a series of sample images are captured at positions of the lens arrangement providing differing focus. The sample images usually cover only a small area of the picture, typically the centre. The sample images are then analysed to compare the quality of the focus of the sample images to determine which of the positions of the lens arrangement provides the best focus. The actuator is then used to move the lens to that position so that a focussed photograph can be taken. Typically, in known closed-loop autofocus algorithms sample images are repeatedly captured and analysed to determine the quality of the focus, this being used to derive a feedback signal which controls an actuator to move the lens arrangement to optimise the focus

Such autofocus algorithms, whether closed-loop or open-loop, require an actuator to move the lens arrangement. The actuator is necessarily a precision device of some complexity, typically an electromechanical actuator such as an electromagnetic motor, for example a stepper motor, or a piezoelectric actuator. For example in the case of open-loop control, the actuator must allow precise control to return to the position determined to provide the best focus. Such precision motors and actuators are relatively costly to manufacture. In addition, the actuator adds significant bulk and mass to the camera, which is undesirable in portable devices such as mobile phones. Further, actuators draw power during operation, using up battery life.

It would be desirable to reduce these problems arising from the need to provide an actuator capable of precise and repeatable control.

In accordance with a first aspect of the present invention, there is provided a digital camera comprising:

an image sensor for capturing an image;

a lens arrangement arranged to focus light onto the image sensor and providing a variable focus;

a memory for storing images captured by the image sensor; and

a controller arranged to control the operation of the digital camera, the controller being arranged to perform an image capture operation comprising:

causing a series of images, each consisting of the entire image area and having differing focus provided by the lens arrangement to be captured by the image sensor and stored in the memory; and

analyzing the images stored in the memory to determine the quality of the focus of the images and on the basis of the analysis deriving an in-focus image from the series of images.

In accordance with a second aspect of the present invention, there is provided a focusing method for a digital camera having an image sensor for capturing an image, a lens arrangement arranged to focus light onto the image sensor and having a variable focus, and a memory for storing images captured by the image sensor, the autofocus method comprising:

capturing a series of images, each consisting of the entire image area, and storing them in the memory; and

analysing the images stored in the memory to determine the quality of the focus of the images and on the basis of the analysis deriving an in-focus image from the series of images.

Thus the focus of the lens arrangement is varied and images are captured with differing focus. The captured images are not the sample images comprising part of the entire image area, as in some prior art techniques summarised above, but consist of the entire image area required by the user. Analysis of the images is then carried out to determine the quality of the focus. On the basis of the analysis, an in-focus image is then derived for use as the photographic shot, for example by being displayed on a display of the camera and/or stored in the memory of the camera. In the simplest application of the invention, the in-focus image is derived by selecting one of the images of the series determined to have the best focus, but in more complex applications, the in-focus image is synthesized from the series of images, as described in more detail below.

The advantage of the invention is that less precise control of the lens arrangement is needed. For example, in contrast to open-loop autofocus technique summarised above, the lens arrangement does not need to be physically returned to the best in-focus position to take the photographic shot, as the appropriate image is derived from the series of images available in storage. An actuator capable of accurate or reproducible positioning is therefore not required. In one type of embodiment described further below no actuator is necessary at all which is a significant advantage. Even if an actuator is used, there is an important advantage that is not necessary to provide the same degree of precise accurate control as with the known autofocus techniques. This can reduce some or all of the complexity, cost and bulk of the actuator used.

Another advantage of the invention is that the time required to obtain a focussed image is reduced as compared to the open-loop autofocus algorithm described above as there is no need to perform the final step of returning the lens arrangement to the position of best focus before capturing the output image.

In the case that an actuator is employed to move the lens arrangement, the digital camera further comprises an actuator arranged to move the lens arrangement, and the image capture operation further comprises controlling the actuator to move the lens arrangement to vary the focus, said capture of the series of images being performed as the actuator is thus moved.

The invention may be applied to a piezoelectric actuator. Piezoelectric actuators provide many advantages, notably small size and low power consumption. However, many piezoelectric actuators suffer from hysteresis which makes the position of the lens arrangement unpredictable from the control signal and hence renders it difficult to apply an open-loop autofocus algorithm requiring return to a position previously determined to provide the best focus. However the present invention provides an in-focus image without the need for such return to a previously identified position. This allows use of a piezoelectric actuator with the associated advantages.

The invention may be applied to an actuator in the form of an electrical motor. In this case, instead of requiring a precision stepper motor as commonly used in cameras providing autofocus, it is possible to use a simpler and cheaper motor such as a DC motor as precise control or knowledge of the position is not needed.

In the type of embodiment in which no actuator is necessary, the digital camera further comprises:

a button operable by a user; and

a mechanical linkage connecting the button to the lens arrangement and adapted to move the lens arrangement on operation of the button, the controller being arranged to perform said image capture operation in response to operation of the button with the series of images being captured as the lens arrangement is moved on operation of the button.

Thus, the movement of the lens arrangement is driven mechanically through the mechanical linkage by operation of the button. That is, the motive force for movement of the lens arrangement originates from the operation of the button and hence from the user. Hereinafter the button will be referred to as the “shutter button” or “shutter release button” to refer to the button the user operates to capture an image. It is noted that in general in digital cameras there is no mechanical “shutter” and this terminology does not imply the presence of any shutter but is simply derived from previous functionality of film cameras.

One option is that when the user depresses the button, a simple mechanical linkage causes the lens to move the requisite distance. This may be a direct connection of a simple mechanism such as a lever to change the direction of the applied force or the gearing. In a miniature camera, the lens diameter is a few millimetres and the corresponding mass of the lens assembly a few grams or less so the required force is hardly noticable to the user. Typically, the lens needs to move about 0.2 mm to cover the range of possible focus positions. Thus a direct connection is possible. If the operator depresses the button further, say by 1-2 mm, a simple lever mechanism or other geared mechanism suffices to effect movement. The mechanical linkage may be of any suitable form. Preferably it comprises one or a few components formed as plastic mouldings.

Another option is that the linkage mechanism is arranged to move the lens arrangement from its rest position by depression of the button and further comprises: a resilient element (most simply a compression spring) arranged to bias the lens arrangement back towards its rest position after depression of the button; and a damper arranged to control the speed of movement of the lens arrangement back towards its rest position, the controller being arranged to perform said image capture operation with the series of images being captured as the lens arrangement is moved back towards its rest position after depression of the button. Thus, the action of depressing the button stresses the resilient element which then causes the lens arrangement to move back towards its rest position under the control of the damper which controls the movement in a predetermined manner. Such a damper could be implemented with a classic “dash-pot” using a viscous liquid, or more preferably could be a lossy/mechanically resistive plastic material. The resilient element and the damper could be fabricated from one and the same plastic moulding (possibly multi-shot) by suitable choice of geometry and material combination.

This provision of automatic return mechanism removes operator dependency from the lens dynamics during the picture-capture sequence. Lens travel is therefore known and repeatable so that timings of image capture (lens position) can be accurately pre-selected.

An optional feature is to provide an optical sensor to sense dark and light marks on the lens barrel assembly, such optical marks representing positions (or transition points between positions) of various focus positions at which it is desired to capture the sequence of images. The signals from the optical sensor then may be used to trigger the image capture process, independently of any reliance on actuator motion, accuracy or repeatability, or of lens velocity during the sequence.

The present invention may be used in any size of digital camera, but advantageously the digital camera is a miniature one, that is, one in which the lens diameter is a few millimetres, say in the range 2 mm to 20 mm. At this small size, the mechanical load on the linkage is slight, as the mass of the lens elements is small (a few grams or less) so that depression of the button by the user is straightforward, that is, depression of the button does not meet with great resistance and can be engineered to have a good ‘feel’ to the user.

As to the number of images in the series, increasing the number improves the approximation to perfect focus. For some applications, two or three focus positions suffice to provide one image approximately in focus. For best focus when used with high resolution image sensors, say 3 megapixel or more, better results are obtained when more lens positions are used, say 10 or more. In practice, capturing images at 5 to 7 lens positions generally provides one image which is adequately focussed.

In a first type of embodiment, the series of images are all stored for subsequent analysis and determination of an in-focus image. In this case the memory requirement is relatively high. Typical memory requirements are of the order of 3× megabytes for an image at × megapixel resolution. Thus, for example, a single frame of a 3 megapixel camera requires of the order of 9 megabytes of storage space. However, alternative formats and compressions are available which reduce the memory required to the order of 1-2 megabytes for a 3 megapixel camera. Thus sufficient temporary memory must be provided to allow storage of the number of images in the series. After the analysis, the determined in-focus image is available for display and further storage, while the remaining images in the series can be erased, freeing up the memory, or can be simply overwritten when the memory is next required.

In a second type of embodiment, the images are analysed in real time by:

initially storing the first image of the series as said in-focus image and

in respect of each successive image in the series analysing the image to determine the quality of the focus of the image in comparison with the image stored as said in-focus image and on the basis of the analysis updating the image stored as said in-focus image.

This second type of embodiment requires less memory than the first type of embodiment, since the most images required to be stored at any one time is two, ie the most recently captured image in the series and the in-focus image being updated, rather than the total number in the series. On the other hand, the second type of embodiment needs a sufficiently high processing speed, or a low rate of capture of the series of images, in the sense that one image must be fully analysed before the start of the readout of the next from the image sensor into memory. Typical frame rates in digital cameras are 30 per second, in which case the time available for image comparison is of the order of 33 ms.

There are several ways to derive the in-focus image from the series of images.

One option for deriving the in-focus image is to select one of the images having the best focus. The analysis of the quality of focus may be performed on the basis of an area of analysis which is a partial area of the entire images, for example a central area, or on the basis of the entire image area.

Another option for deriving the in-focus image is to synthesise the in-focus image from the series of images, for example as a composite of more than one of the images of the series. This may be achieved by determining the quality of the focus of the images in each of a plurality of parts of the image and selecting, in respect of each of said plurality of parts of the image area, the part of the image area determined to have the best focus from one of the series of images. Thus different parts of the in-focus image may originate from different images captured at different focus positions, allowing all areas of the picture to appear in focus. This can increase the apparent depth-of-field of the camera. In this embodiment, the selections are made on a part-by-part basis. In general, the quality of the focus of the images may be determined in each of a plurality of parts of the image on the basis of an area of analysis which is any of (a) a partial area of the part of the image area, (b) the entire area of each part of the image area, or (c) the entire area of that part of the image area and an adjacent area.

The parts of the image area may be regions of a plurality of pixels. In this case, it is possible to select the part of the image area from one of the series of images determined to have the best focus in that part of the image area. For best effect, the size of the regions needs to be relatively small and the number of lens positions relatively large. Simulations indicate that for a 3 megapixel sensor, a high quality picture can be obtained with between 9 and 25 regions of roughly equal area and between 3 and 10 lens positions. The regions may have any shape and arrangement. The boundaries of the regions may be chosen to be “ragged” rather than straight lines. Also the regions may usefully have a dominantly hexagonal perimeter rather than rectangular. Both these features make the region boundaries far less noticeable to the human eye.

Alternatively, the parts of the image may each comprise a single pixel. In this case, the quality of the focus of the images is determined for each pixel on the basis of an area of analysis consisting of the pixel and an adjacent area of the image. The great advantage of this scheme over the previously described process, is that there are no artificially introduced boundaries between different parts of the final composite in-focus image, across which boundaries significant focus error might be visible. Instead, this process effectively makes every pixel a region in its own so the resultant composite will have no region boundaries visible whatsoever.

To allow better understanding, an embodiment of the present invention will now be described by way of non-limitative example with reference to the accompanying drawings, in which:

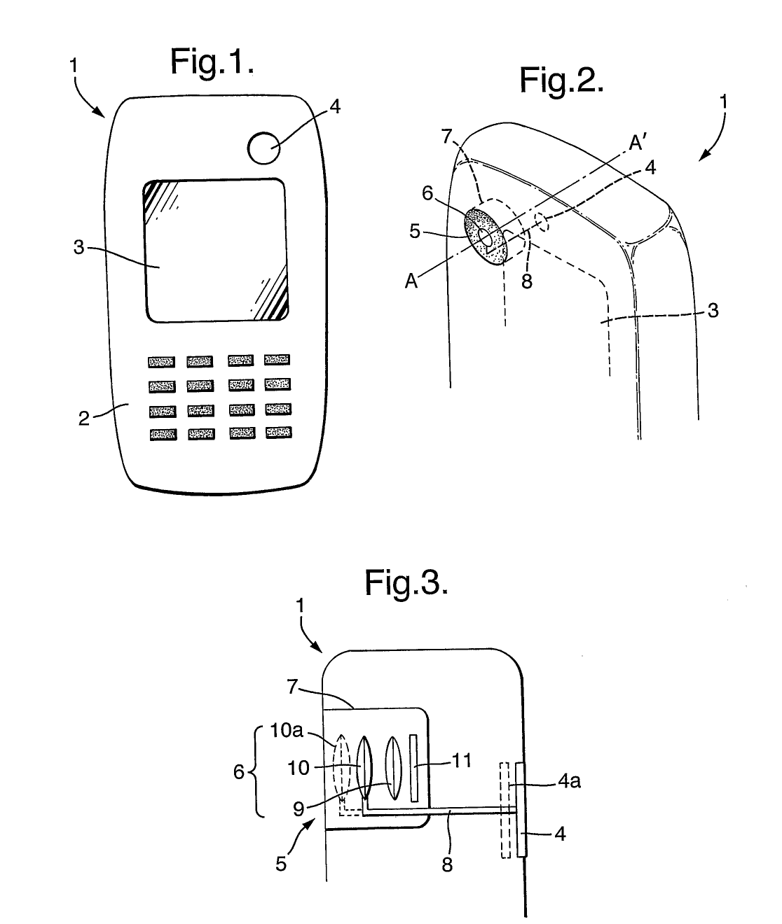

FIG. 1 is a front view of a mobile telephone including a camera;

FIG. 2 is a perspective, rear view of the lens arrangement of the camera;

FIG. 3 is a cross-sectional view of the arrangement of the optical components of the camera, the cross-section being taken along the line AA′ in FIG. 2;

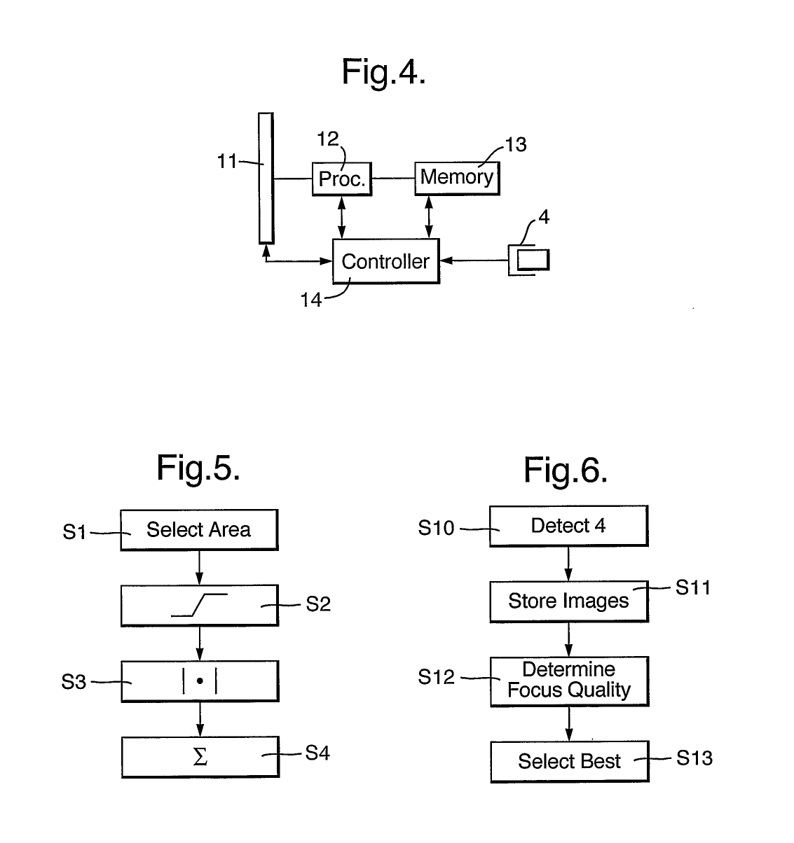

FIG. 4 is a diagram of the electronic components of the camera;

FIG. 5 is a flow chart of the analysis performed by the camera to determine the quality of the focus of an image;

FIG. 6 is a flow chart of a first image capture operation of the camera;

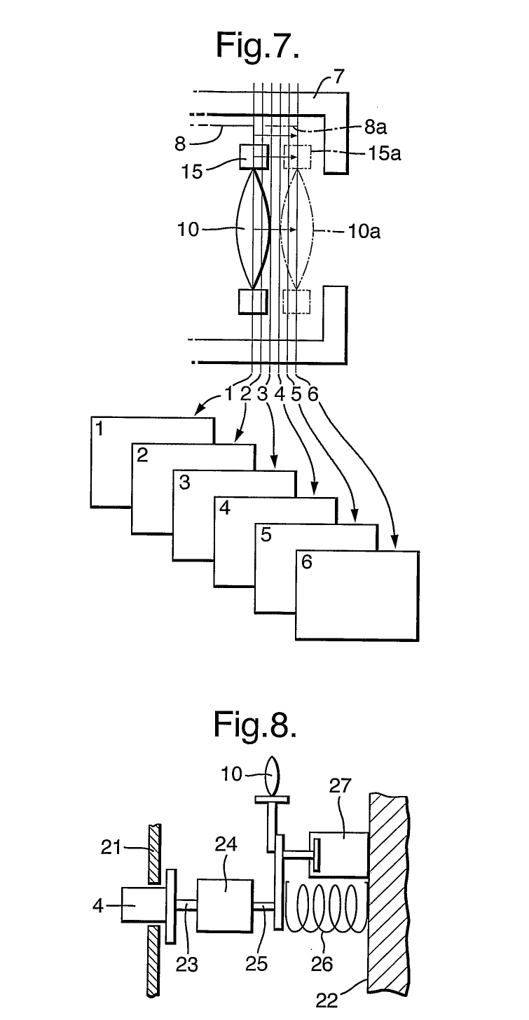

FIG. 7 is a schematic view of a series of images captured by the camera at successive positions of the lens arrangement;

FIG. 8 is a side view of a modified form of linkage mechanism for the shutter release button of the camera;

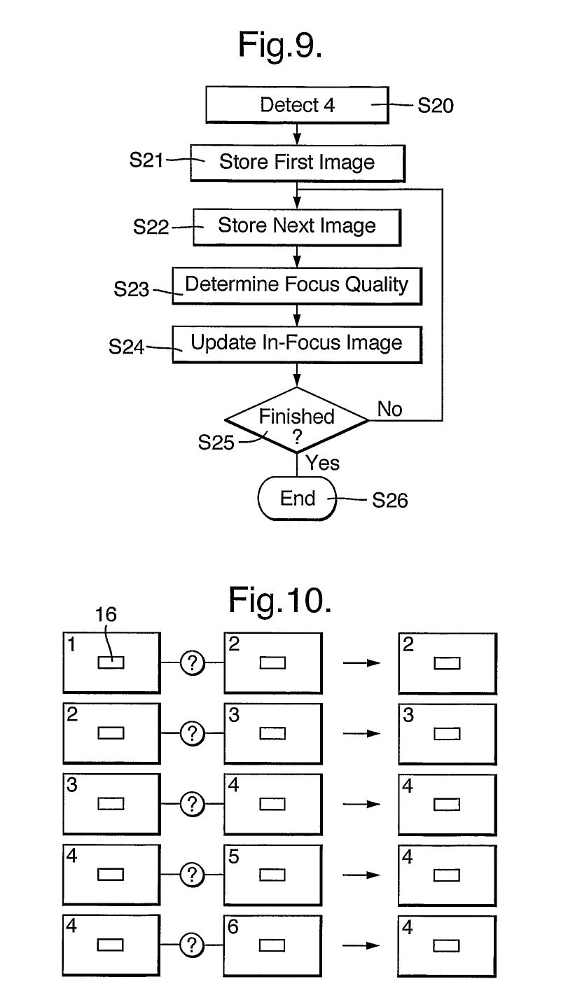

FIG. 9 is a flow chart of a first image capture operation of the camera;

FIG. 10 is a schematic view of an example of the images processed by the first image capture operation of FIG. 9;

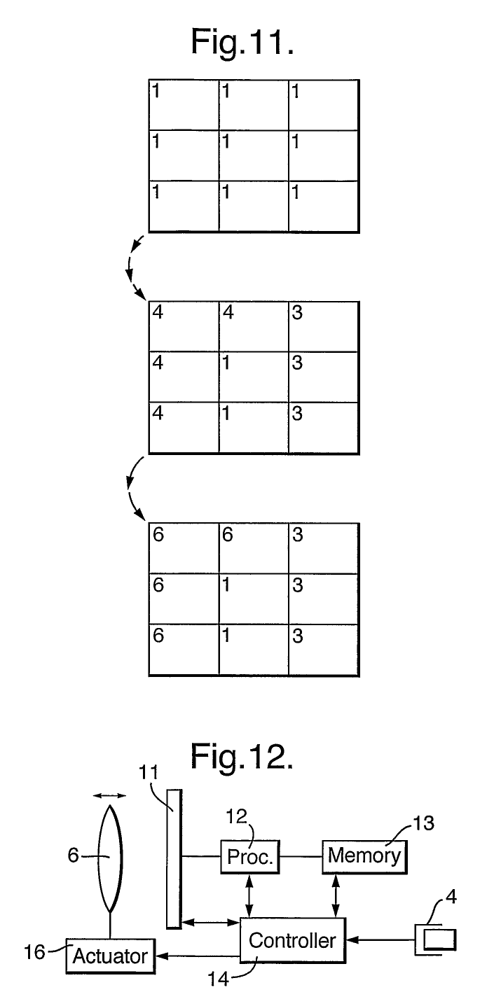

FIG. 11 is a schematic view of another example of images processed by the first image capture operation of FIG. 9;

FIG. 12 is a diagram of the camera in an alternative form employing an actuator.

FIG. 1 shows a mobile phone 1 in which a camera 5 in accordance with the present invention is provided. The mobile phone 1 has on its front surface a keypad 2 and a display screen 3, as well as a shutter release button 4 of the camera 5.

As best seen in FIG. 2, the camera 5 has a housing 7 in which is mounted a lens assembly 6 arranged towards the rear of the mobile phone 1 to receive light from the exterior of the mobile phone 1. As shown in FIG. 2, the lens assembly 6 comprises a fixed lens 9 and a movable lens 10. The lens assembly 6 is arranged in front of an image sensor 11 to focus the received light onto the image sensor 11. The lens assembly 6 is movable, in particular by movement of the movable lens 10 to vary the focus of the light on the image sensor 11. For clarity, the fixed and movable lenses 9 and 10 are depicted as simple lenses, whereas in reality they are generally formed by lens groups.

As shown in dotted outline in FIG. 2 and in detail in FIG. 3, the camera 5 has a mechanical linkage 8 connecting the shutter release button 4 to the lens assembly 6, in particular to the movable lens 10. In this case the mechanical linkage 8 is a simple rod. On depression of the shutter release button 4 by the user, the button 4 moves to the position shown by dotted lines 4a, the mechanical linkage 8 moves together with the button and drives the movable lens 10 to move to the position indicated by dotted lines 10a, thereby varying the focus of light on the image sensor 11.

In addition, the camera 5 has electrical components of the camera 5 as shown in FIG. 4 and arranged as follows.

The image sensor 11 is connected to supply the output image signal of captured images through a signal processor 12 to a memory 13. As discussed further below, in operation images consisting of the entire image area are stored in the memory 13. The operation of the image sensor 11, the signal processor 12 and the memory 13, as well as other components of the camera 5 are controlled by a controller 14. The controller 14 is also responsive to operation of the shutter release button 4. The controller 14 is typically implemented by a microprocessor running an appropriate program. Alternatively some or all of the functions of the controller 14, for example the analysis of the captured images to determine the focus quality as described below, may be implemented by dedicated hardware.

The controller 14 analyses the quality of the focus of images stored in the memory 13 using an algorithm shown in FIG. 5. In step S1, an area of analysis of the image is selected. This area of analysis may be the entire image area or may be a partial area of the entire area, for example a central portion or a plurality of portions of the entire area.

In step S2, the selected area is filtered by a high-pass filter. The high-pass filter is used on the basis that the high spatial frequency components increase with better focus, so the output of the high-pass filter is representative of the focus quality. The high-pass filter is designed accordingly. The following can be said about the requirements for this filter:

The DC coefficient must be zero as the DC signal never conveys useful focus information

Very high frequencies are likely to be dominated by pixel noise (if this can be proved by analysis of the circle of confusion of a particular system, that would be very helpful information). These frequencies should also be attenuated.

Intermediate frequencies will contain the useful focus information

The transition bands between these zones should not be too abrupt, otherwise they could act as a threshold, and prevent the algorithm working under some circumstances.

Designing frequency domain filters from spatial prototypes is one way to get satisfactory results. Knowing what convolution operation is needed in the spatial domain, this can be transformed into a frequency domain multiplication.

One possible high-pass filter is the Laplacian of a Gaussian filter.

The high-pass filter may be implemented in the frequency domain. One possibility is to perform a discrete cosine transform, eg on 8×8 pixel blocks. Then the measure of focus quality might be derived by multiplying the spatial frequency components by the frequency domain filter coefficients.

In step S3 the absolute values of the output of step S2 are taken and in step S4 the absolute values are summed. As an alternative to taking the absolute value in step S3, the power could be calculated, but the absolute value calculation is computationally cheaper than a power calculation and is nearly as useful.

Thus the output of step S4 gives a measure of the quality of the image focus. This algorithm shown in FIG. 5 produces quite satisfactory results and compares well in simulation with other methods (some frequency based, some spatial based). However it will be appreciated that other algorithms for determining focus quality could alternatively be applied.

A first image capture operation performed by the controller is shown in FIG. 6 and will now be described.

In step S10, depression of the button 4 is detected. In response to this, the operation proceeds to step S11 in which the controller 14 causes a series of images to be captured by the image sensor 11 and stored in the memory 13. Each stored image consists of the entire image area. This may correspond to the entire area of the image sensor 11, but in some cases it may be that some of the peripheral pixels of the image sensor 11 are discarded. These images are stored at predetermined times after initial depression of the button 4 so that each stored image is an image captured at a different position of the lens arrangement 6 and having a different focus.

This is shown for example in FIG. 7 which shows a schematic cross-section of the part of the camera 5 housing the lens assembly 6. The movable lens 10 is supported in a lens holder 15 which may be a barrel, both of which are circularly symmetric. The lens holder 15 is attached to the mechanical linkage 8 capable of moving the lens holder 15 in a direction parallel to the optic axis (horizontal in the drawing). The lens holder 15, movable lens 10 and mechanical linkage 8, together with other components such as suspension, fixed lenses and image sensor (not shown) are housed in the housing 7. During the depression of the button 4, the mechanical linkage 8 moves the lens holder 15 and thereby the movable lens 10 to the positions shown by dotted lines and denoted 8a, 15a and 10a, as indicated by the horizontal arrows. During the movement of the lens assembly 6, full images are captured and stored in the memory 13 at several positions of the movable lens 10, indicated by the fine vertical lines labelled 1-6, position 1 corresponding to near focus and position 6 to far focus. In this example, 6 lens positions are used but fewer or more lens positions could be used. A full image is captured at position 1 at the start of travel and position 6 at the end of travel and at four intermediate positions, 2-5. The six images captured by the image sensor during lens travel are indicated schematically in the lower part of FIG. 7.

Although the number of images in the series is shown as being six in FIG. 7, in general it may be any plural number.

In step S12 of FIG. 6 which is performed after all the images have been stored in the memory 13, the focus quality of each image is determined using the algorithm shown in FIG. 5. Then in step S13, the image having the best focus quality is selected as the in-focus image. This in-focus image is displayed on the display screen 3 and retained in the memory 13.

As will be apparent to those skilled in the art, the mechanical linkage 8 may in general be readily adapted to connect a shutter release button 4 and a lens assembly 6 whatever their positions in the phone, and further, may be designed to produce the desired extent and speed profile of movement of the lens assembly 6. For example, the linkage mechanism 8 may incorporate a spring and damper system, arranged so that no matter how fast the button 4 is depressed, the movement of the lens arrangement 6 is essentially controlled by the spring stiffness and damper resistance. Return of the lens assembly 6 to its starting position may be readily incorporated, for example using a return spring.

Similarly, the capture and storage of the series of images may occur during the return of the lens assembly 6 to its original position instead of during the depression of the button 4. In this case, the movement of the lens assembly 4 is still driven by the operation of the button 4 by the user, but there is the advantage that the movement of the lens assembly 6 may be better controlled as it is less dependent on the action of the user. All such designs are included in the scope of the invention.

A modified form of the linkage mechanism 8 which facilitates the capture and storage of the series of images during the return of the lens assembly 6 to its original position is shown in FIG. 8. In FIG. 8, two opposing walls 21 and 22 of the housing of the mobile phone 1 are shown, these walls being nominally fixed and the linkage mechanism being arranged therebetween. The shutter release button 4 protrudes through one of the walls 21 and connects via stiff linkage 23 to an over-travel-disconnect mechanism 24, which in turn connects via a stiff linkage 25 to one end of a spring 26. The other end of the spring 26 reacts with the wall 22 of the housing of the mobile phone 1. The spring 26 may be replaced by any resilient element. The linkage 25 also connects to a damping mechanism 27 (e.g. a dashpot, or other viscous-characteristic damping device) which also reacts with wall 22 of the housing of the mobile phone 1. Lastly, the linkage 25 connects mechanically with the movable lens 10 of the lens assembly 6, this being the primary object to be moved by the linkage mechanism 8.

Over-travel-disconnect mechanism 24 acts in such a way as to transmit any compressive force applied to the shutter release button 4, until such time as a certain depression (to the right in FIG. 8) is reached. After that the shutter release button 4 is effectively disconnected until such time as the linkage 25 (under reverse drive from compressed spring 26) has returned to its rest position, as shown in FIG. 8 and as limited for example by the wall 21. Any suitable conventionally known mechanism will suffice here.

Operation of the linkage mechanism 8 is as follows. Initially the spring 7 is largely uncompressed and shutter release button 4 is in its rest position (to the left in FIG. 8). The user depresses the shutter release button 4 (to the right in FIG. 8), the user's compressive force being transmitted to linkage 25 via the over-travel-disconnect mechanism 24. This causes the linkage 25 to follow the movement of shutter release button 4, in so doing compressing spring 26 and depressing damper 27, and driving the movable lens 10 to an extreme position. When shutter release button 4 gets close to its end of travel, the over-travel-disconnect mechanism 24 trips in, effectively disconnecting the shutter release button 4 from the linkage 25. Thereafter, the linkage 25 and its connected components (the spring 26, the damper 27 and the movable lens 10) are free to move back towards their rest positions (to the left in FIG. 8) under the reaction force of compressed spring 26 with velocity controlled by friction and predominantly by damper action from the damper 27. These together produce smooth traversal of the movable lens 10 across its operating range at essentially constant velocity (and if desired, through different velocity profiles are possible by careful design and profiling of the damper 27).

The controller 14 is operative to cause capture and storage of the images during the return movement of the linkage 25 and the movable lens 10.

Advantageously, the normal rest position of the lens assembly 6 is set to the hyperfocal distance for the lens assembly, so that as much of the scene as possible is in focus all the time when the camera is being panned around. This would be a factory pre-set position. In this case, the linkage mechanism 8 could be arranged to allow operation as follows. On depression of the button 4, the lens assembly 6 is pushed back to one end of its range (say the minimum focal distance) and stays there until button 4 reaches the end of its travel, ie without the need for the button 4 to be released. The button 4 might usefully emit a noise when this end of travel position is reached, by, for example, pushing back an arm that is released at end of travel, the arm then returning and striking another element to produce a noise. Once end of travel has been reached, the focus image sequence occurs as already described, powered by a spring that was compressed by the user on the downstroke of the button 4. Once the lens assembly 6 reaches its other end of travel, it trips another lever (or perhaps electronic switch) which then decouples the lens assembly 6 from the return-stroke spring, after which the position of the lens assembly 6 is under the control of a weaker spring that simply returns the lens assembly 6 to the hyperfocal distance. In this context, the “spring” may be any resilient element but is probably just implemented by a piece of bent plastic, metal or a bent wire. This is likely to work well because the hyperfocal distance (HFD) return mechanism only needs to be strong enough to move the lens assembly 6 which is light, whereas the button powered return stroke system can be much more powerful (enough to completely override the HFD return system) because it is powered by the user who is relatively strong and is geared down, say by the order of ten times.

A second image capture operation alternatively performed by the controller is shown in FIG. 9 and will now be described. Whereas in the first image capture operation, analysis of the series of images is performed after all the images have been stored in the memory 13, in the second image capture operation the images are analysed on-the-fly, thereby reducing the memory requirments.

In step S20, depression of the button 4 is detected. In response to this, the operation proceeds to step S21 in which the controller 14 causes the first image in the series to be captured by the image sensor 11 and stored in the memory 13 as the in-focus image, this image consists of the entire image area. Next in step S22, the controller 14 causes the next image in the series to be captured by the image sensor 11 and stored in the memory 13 separately from the in-focus image, the stored image consisting of the entire image area . . . Each image is stored in steps S21 and S22 at the same predetermined times after initial depression of the button 4 as in the first image capture operation so that each stored image is an image captured at a different position of the lens arrangement 6 and having a different focus.

After that, in step S23 the focus quality of that next image is determined using the algorithm shown in FIG. 5, and the focus quality of the in-focus image is also so determined (if not already determined in a previous iteration of step S23). In step S24, the focus qualities of the next image and the in-focus image are compared and the image having the best focus quality is stored as the in-focus image, for example by overwriting the previous in-focus image if the next image has a better focus quality.

In step S25, it is determined if all the images in the series have been stored and analysed. If not, the operation returns to step S22. Once all the images in the series have been stored and analysed, the process finishes in step S26 in which case the image of the series having the best focus quality has been retained as the in-focus image. Thus the result is the same as the first image capture operation but less space of the memory 13 has been used albeit with the requirement of speedy analysis in steps S23 and S24.

An example of the second image capture operation in which the fourth image is found to have the best focus quality is shown in FIG. 10. The images are identified by their numbers as in FIG. 7 and the area of analysis 19 is shown as being a partial area of the entire image area. Each row indicates a comparison performed in step S24 by a question mark, the first column of images being the stored in-focus images and the second column being each successive new image. The final column indicates the image stored as the in-focus image as a result of the comparison. Thus in the first three comparisons, the in-focus image is updated each time to give the fourth image as the in-focus image, whereafter there is no change of the in-focus image.

As described above, the first and second image capture operations result in selection of an entire one of the images in the series as the in-focus image. As an alternative, step S13 of the first image capture operation and step S24 of the second image capture operation may be altered by notionally dividing the image area into a plurality of parts and selecting each part from one of the images in the series. The result is that the in-focus image may be a composite image formed from more than one of the images in the series.

Division into any number of parts of the image is possible. As the number increases, the overall focus quality improves but an increasing processing power is needed. The simplest variant may divide the image into two parts, which could usefully be arranged as a single circular pixel-block in the centre of the image (for focusing an object of interest) surrounded by a second pixel-block (for focusing the background).

The parts may in general have any shape and size. To reduce the required processing the parts may comprise a region of a plurality of pixels in any shape, for example rectangles, triangles or hexagons, which may have boundaries which are straight or wavy to allow adjacent regions to interlock and thereby reduce the visibility of boundary artefacts. The regions may be regularly or irregularly arranged and may have the same or different sizes.

To increase the resolution, the parts of the image could be very small, for example a single pixel or a single pixel and its nearest neighbours, say 5 or 9 pixels. This gives the highest resolution of all but may be prone to interference from noise in the image since the signal to noise ratio at the pixel level may be high. However, the focusing process can be modified to allow for noise if the noise level is known. The noise level can be estimated for example from: known characteristics of the sensor chip; overall or local brightness of the scene (a dim scene will have more noise); and the ambient temperature (noise increases at higher temperatures), which can be measured by measuring the voltage on a single transistor.

Where regions are used, the selection of each part of the image area is preferably performed on the basis of a determination of the focus quality of the image in the area in question. However where smaller parts of the image are used it may be desirable to select each part of the image on the basis of a determination of the focus quality of the image in an analysis area consisting of the part of the image in question and an adjacent area of the image.

An example of the second image capture operation applied with selection of parts of the image area independently is shown in FIG. 11, for the case of using nine rectangular regions as the parts of the image. In FIG. 11, the upper drawing denotes the in-focus image composition at the start of the process, that is at lens position 1; the middle drawing denotes the image composition after 3 comparison process steps at lens position 4; and the lower drawing shows the final image composition after the last processing step at lens position 6. In this example, the central and lower-central regions are best in-focus at lens position 1, corresponding to a near or foreground object; the regions to the right are best in-focus at lens position 3, corresponding to intermediate distance; and the remaining regions are best in-focus at lens position 6, corresponding to infinity.

As described above, the autofocus operation may be linked to operation of the shutter release button 4, that is when the user desires to take a photograph. Alternatively, the autofocus operation can be caused to occur at other times also. This is useful if the user wants to view an in-focus image on the display 3 before taking a photograph. For this purpose, a focus button can be provided in addition to the shutter release button 4. Alternatively, the shutter release button 4 can be arranged to trigger the autofocus operation separately from the photograph-taking operation. However, since at a minimum, to be useful an autofocus operation will either capture and store a focussed image, or, capture and display a focussed image, or both, it can be equally useful to simply provide for two modes of camera operation; in mode 1, depression of the shutter release button 4 causes the entire multi-image capture, focus selection process, and final best-focussed image display only (with an option to subsequently store more permanently that displayed image); and in mode 2, all of the mode 1 operations occur with the best-focussed image automatically being transferred to more permanent storage. So Mode 1 is a “look and see” mode, while mode 2 is most similar to conventional point-and-shoot. Alternatively, the shutter release button 4 can be designed such that the first part of the travel of the button 4 causes the autofocus mechanism to operate and the second part of the travel of the button 4 causes a photograph to be taken. Thus the first part results in an in-focus image being displayed but not stored as a photograph, while in the second part, the in-focus image is both displayed and stored.

The camera 5 described above could be adapted as shown in FIG. 12 to use an actuator 15 to drive movement of the lens assembly 6 instead of the linkage mechanism. In this case, the controller 14 controls the actuator 15 to move the lens assembly 6 (or more specifically the movable lens 10) in response to operation of the shutter release button 4. Thus the first or second image capture algorithms may be applied but with the steps S11, S21 and S22 being modified to include control of the actuator 15 and to cause capture and storage of the images at the appropriate values of the control signal applied to the actuator 15. The actuator may be a piezoelectric actuator, for example of the type disclosed in WO-01/47041 which may be used in a camera as disclosed in WO-02/102451.In this case, the lens arrangement 6 may be suspended using a suspension system incorporating the actuator 15 as disclosed in WO-2005/003834. Alternatively, the actuator 15 may be an electric motor such as a DC motor.

The camera 5 described above is a still-picture camera 5 but could easily be adapted to be a video camera employing the same focussing method.

1. A digital camera comprising:
an image sensor for capturing an image;
a lens arrangement arranged to focus light onto the image sensor and providing a variable focus;
a memory for storing images captured by the image sensor; and
a controller arranged to control the operation of the digital camera, the controller being arranged to perform an image capture operation comprising:
causing a series of images, each consisting of the entire image area and having differing focus provided by the lens arrangement, to be captured by the image sensor and stored in the memory; and
analyzing the images stored in the memory to determine the quality of the focus of the images and on the basis of the analysis, selecting one of the series of images determined to have the best focus as an in-focus image: and
in respect of the in-focus image performing either one or both of:
(a) displaying the in-focus image on a display of the digital camera; and
(b) retaining the infocus image in the memory in a manner allowing the user subsequently to retrieve the in-focus image from the memory.

2. A digital camera according to claim 1, wherein the lens arrangement is movable to vary the focus.

3. A digital camera according to claim 2, wherein the digital camera further comprises:
a button operable by a user; and
a mechanical linkage connecting the button to the lens arrangement and adapted to move the lens arrangement on operation of the button, the controller being arranged to perform said image capture operation in response to operation of the button with the series of images being captured as the lens arrangement is moved on operation of the button.

4. A digital camera according to claim 3, wherein the linkage mechanism is arranged to moved the lens arrangement from its rest position by depression of the button and further comprises:
a resilient element arranged to bias the lens arrangement back towards its rest position after depression of the button; and
a damper arranged to control the speed of movement of the lens arrangement back towards its rest position,
the controller being arranged to perform said image capture operation with the series of images being captured as the lens arrangement is moved back towards its rest position after depression of the button.

5. A digital camera according to claim 2, wherein the digital camera further comprises an actuator arranged to move the lens arrangement, and the image capture operation further comprises controlling the actuator to move the lens arrangement to vary the focus, said capture of the series of images being performed as the actuator is thus moved.

6. A digital camera according to claim 5, wherein the actuator is a piezoelectric actuator or an electric motor.

7. (canceled)

8. A digital camera according to claim 6, wherein the quality of the focus of the images is determined on the basis of an area of analysis which is a partial area of the entire image area.

9. (canceled)

10. (canceled)

11. (canceled)

12. (canceled)

13. (canceled)

14. (canceled)

15. A digital camera according to claim 1, wherein said step of said image capture operation which said controller is arranged to perform of analyzing the images stored in the memory to determine the quality of the focus of the images and, on the basis of the analysis, selecting one of the series of images determined to have the best focus as an in-focus image is performed after all the series of images have been stored in the memory.

16. A digital camera according to claim 1, wherein said step of said image capture operation which said controller is arranged to perform of analyzing the images stored in the memory to determine the quality of the focus of the images and, on the basis of the analysis, selecting one of the series of images determined to have the best focus as an in-focus image is performed as successive images of the series are captured by
initially storing the first image of the series as said in-focus image and
in respect of each successive image in the series analysing the image to determine the quality of the focus of the image in comparison with the image stored as said in-focus image and on the basis of the analysis updating the image stored as said in-focus image.

17. (canceled)

18. (canceled)

19. A focus method for a digital camera having an image sensor for capturing an image, a lens arrangement arranged to focus light onto the image sensor and having a variable focus, and a memory for storing images captured by the image sensor, the autofocus method comprising:
capturing a series of images on the image sensor, each captured image consisting of the entire image area, and storing the captured images in the memory; and
analysing the images stored in the memory to determine the quality of the focus of the images and, on the basis of the analysis, selecting one of the series of images determined to have the best focus as an in-focus image and
in respect of the in-focus image performing either one or both of:
(a) displaying the in-focus image on a display of the digital camera; and
(b) retaining the in-focus image in the memory in a manner allowing the user subsequently to retrieve the in-focus image from the memory.

20. (canceled)

21. (canceled)

22. (canceled)
